(19) United States
(12) Patent Application Publication
(10) Pub. No.: US 2009/0069951 A1
(43) Pub. Date: Mar. 12, 2009

(54) METHOD AND A SYSTEM FOR DETERMINING THE LOAD TRANSFERRED FROM A SEMI-TRAILER TO A FIRST AXLE OF A TOWING VEHICLE

(75) Inventors: Benny Liljeblad, Lerum (SE); Tobias Vikstrom, Lerum (SE); Bengt Terborn, Olofstorp (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/577,507

(22) PCT Filed: Oct. 18, 2005
(86) PCT No.: PCT/SE05/01553

§ 371 Date: Apr. 19, 2007

(30) Foreign Application Priority Data
Oct. 29, 2004 (SE) 0402633-2

(51) Int. Cl. G06F 17/00

(52) U.S. Cl. 701/1; 280/423.1

(57) ABSTRACT

A method and a system determine the load transferred from a semi-trailer to a first axle of a towing vehicle which has at least one further, second axle. The semi-trailer is partly supported by the towing vehicle at a “fifth wheel”. A first value representing the load transferred from the semi-trailer to the second axle is determined by a load sensor and a second value representing the position of the “fifth wheel” in relation to said axles are also determined. Based on these first and second values a value representing the load transferred from the semi-trailer to the first axle is calculated by a calculator. The calculation may be based on the equation L1*d1=L2*d2 or L1=L2*d2/d1.

The present invention generally relates to articulated lorries or vehicles and more particularly to a method and a system for determining the load transferred from a semi-trailer to a first axle of a towing vehicle, which has at least one further, second axle, the semi-trailer being partly supported by the towing vehicle at a supporting site thereof.

U.S. Pat. No. 6,203,045 discloses an articulated lorry with a control system for redistributing the weight among wheel axles. A plurality of sensors is associated with the plurality of wheel axles on the vehicle, and an electronic controller gathers information from the sensors and determines the weight at each axle.

This known system comprising at least one weight sensor at each wheel axle is rather complicated. While the rear wheel axle(s) is/are usually suspended by fluid springs the front axle is usually suspended by mechanical springs. Because it is more complicated and expensive to install an efficient weight sensor when a wheel axle is suspended by mechanical springs than when it is suspended by fluid (hydraulic and/or gas) springs, it would be advantageous if installation of a load or weight sensor at a selected wheel axle could be avoided.

WO03/044471 discloses a load calculation system for a truck with a fixed fifth-wheel coupling.

This is obtained by the present invention, which provides a method of determining the load transferred from a semi-trailer to a first axle of a towing vehicle, which has at least one further, second axle, the semi-trailer being partly supported by the towing vehicle at a supporting site thereof, said method comprising determining a first value representing the load transferred from the semi-trailer to said at least one further, second axle and determining a second value representing the position of the supporting site in relation to said axles using a position detecting device, and the system according to the invention is characterised in calculating a value representing the load transferred from the semi-trailer to the first axle based on said first and second values. Such a towing vehicle is often referred to as a tractor.

By the method according to the invention it is possible to determine how an unknown load transferred from a semi-trailer to at vehicle towing the same is distributed to the axels of the towing vehicle, provided that the load supported by the said second axle and the position of the supporting site or the so-called “fifth wheel” are known. Since the supporting site or “fifth wheel” is moveable, the position of the supporting site or “fifth wheel” is determined using a position detecting device. The load transferred to the first axle or a value representing the same may, for example, be calculated by using static calculations. The net weight or unladen weight of the towing vehicle and also the fraction of such weight supported by the axels of the vehicle are usually known. Therefore, also the total load or weight supported by each of the first and second axle may be determined, if desired.

The position of the supporting site or “fifth wheel” in relation to the axles of the towing vehicle may be changed in order to obtain a desired weight or load distribution on the axles of the towing vehicle, for example to maintain desired braking and/or steering characteristics of the combined vehicle and semi-trailer. The movement of the “fifth wheel” may be manually operated or performed automatically by means of an electronic control device in accordance with predetermined programs.

The supporting site or “fifth wheel” is advantageously displaced between predetermined positions along a track extending longitudinally of the towing vehicle. The “fifth wheel” may, for example, be releasable locked in any of the predetermined positions. The actual position of the supporting site or “fifth wheel” may be determined by any conventional means. In the presently preferred embodiment the supporting site is defined by a displaceable supporting member, which is connected to a fixed part of the towing vehicle by means of an articulated rod member, and the position of the supporting member may then be determined based on the mutual angular position of the rod member parts.

The first axle is usually a front axle while the second axle is a rear axle, and the supporting site is positioned between the front and rear axles of the towing vehicle. However, the said first axle may also be a rear axle. The towing vehicle may have a rear axle in the form of a bogie, or a pair of closely adjacent rear axles. In the latter case the load transferred to such pair of second axles may be determined for each such axle or at a common point of load application.

The load L1 transferred from the semi-trailer to the first axle may be calculated based on the following equation:

L1*d1=L2*d2

or

L1=L2*d2/d1

where the load transferred from the semi-trailer to the second axle is L2 and the longitudinal distances between the supporting site and the first and second axles are d1 and d2, respectively.

If desired, the total load L3 transferred from the semi-trailer to the towing vehicle at said supporting site may be calculated from the equation

L3=L1+L2

The present invention also provides a system for determining the load transferred from a semi-trailer to a first axle of a towing vehicle, which has at least one further, second axle, the semi-trailer being partly supported by the towing vehicle at a supporting site thereof, said system comprising a load sensing device for determining a first value representing the load transferred from the semi-trailer to said at least one further, second axle and a position detecting device for determining a second value representing the position of the supporting site in relation to said axles, and the system according to the invention is characterised in an electronic calculator adapted to receive signals from the load sensing device and from the position detecting device representing said first and second values, respectively, and to calculate a value representing the load transferred from the semi-trailer to the first axle based on said first and second values. Such system may further comprise a display device communicating with the electronic calculator and adapted to display any of the values received and/or calculated by the calculator. The display device is preferably arranged within the driver's cab so that it can be surveyed by the driver.

### BRIEF DESCRIPTION OF DRAWINGS

The invention will now be further described with reference to the drawings, wherein

FIG. 1 is a diagrammatic side view of a towing vehicle and a semi-trailer connected thereto including a system according to the invention, and

FIG. 2 is a perspective view in an enlarged scale of an embodiment of a coupling device or “fifth wheel” of the vehicle shown in FIG. 1.

### DETAILED DESCRIPTION

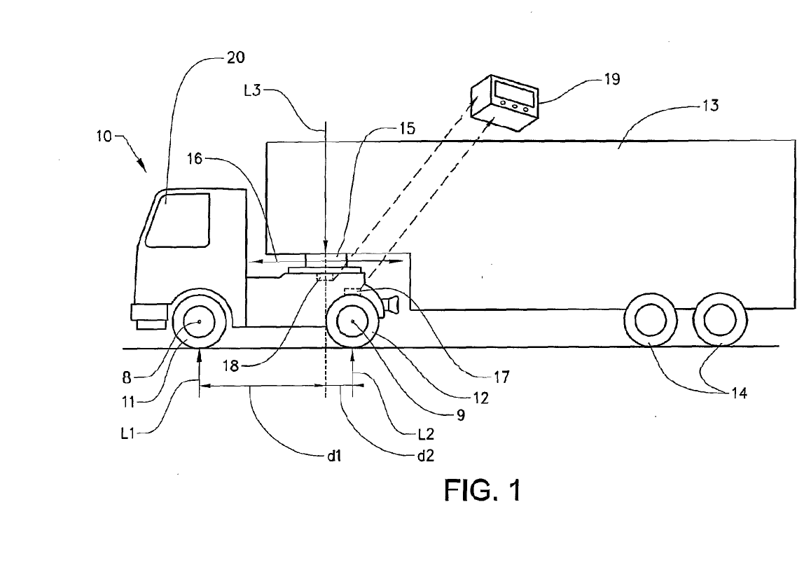

FIG. 1 illustrates a towing vehicle or tractor 10 having a front axle 8 with front wheels 11 and a rear axle 9 with rear wheels 12. A semi-trailer 13 has a rear bogie comprising two pairs of wheels 14 and is releasable coupled to the towing vehicle 10 by means of a coupling device 15, which is longitudinally displaceable in relation to the vehicle 10 as indicated by a double arrow 16 and forms part of the so-called “fifth wheel”. A load L3 is transferred from the semi-trailer 13 to the “fifth wheel” or coupling device 15 and part L1 of this load is supported by the front axle 8 with front wheels 11 and part L2 is supported by the rear axle 9 with rear wheels 12 of the towing vehicle 10.

The tractor 10 is in this example equipped with a leaf sprig as the front axle suspension and an air spring as the rear axle suspension. The axle load for an axle suspended by a leaf spring is difficult to measure in a direct way. This is normally done with a displacement sensor that senses the displacement of the axle and this signal is then transferred to a load value using an equation that compensates for the spring characteristics. The axle load for an axle suspended by an air spring is on the other hand easy to determine, since the axle load can be derived from the air pressure in the air bellows. The air pressure in the air bellows is normally measured on vehicles with air springs. The axle load for that axle is therefore normally available from the electronic air suspension system.

The total load or weight supported by the rear axle 9 is determined by a weight sensor 17, which may be arranged in connection with a hydraulic and/or gas spring suspension system. A known contribution to this total load resulting from the net weight of the towing vehicle 10 should be deducted from the value determined by the sensor 17 in order to arrive at the load value L2. A position detector 18 described more in detail below determines the position of the coupling device or “fifth wheel” 15. In FIG. 1 the axial distance between the front axle and the coupling device 15 is d1 while the axial distance between the rear axle and the coupling device 15 is d2.

When the values L2, d1 and d2 have been determined the value L1 can be calculated from the equation:

L1*d1=L2*d2

or

L1=L2*d2/d1

L1 is the load contribution from the load L3 supported by the front axle 8. If the total load or weight supported by the front axle 8 is to be determined a known contribution from the net weight of the vehicle 10 has to be added. It should be understood that in this way it is possible to determine the total loads supported by the front and rear axles 8 and 9, respectively, and/or the relative weight distribution on the front and rear axles when the load L2 and the spacing d1 and d2 are determined by means of the sensor 17 and the detector 18, respectively. As indicated in FIG. 1 measuring signals from the weight sensor 17 and from the position detector 18 may be transmitted to an electronic calculating and display device 19, which is arranged within the driver's cab 20. However, in FIG. 1 the device 19 is illustrated outside for illustrative reasons. The electronic calculating and display device 19 may also be integrated in the electronic control system of the vehicle. The device may also include a control device for automatically moving the “fifth wheel” 15 so as to obtain a desired load distribution on the front and rear axles 8 and 9 in accordance with a predetermined scheme or program. The distance that the “fifth wheel” 15 is moved or the position of the “fifth wheel” 15 can also be displayed to the driver. This enables the driver to determine the change in the total length of the vehicle.

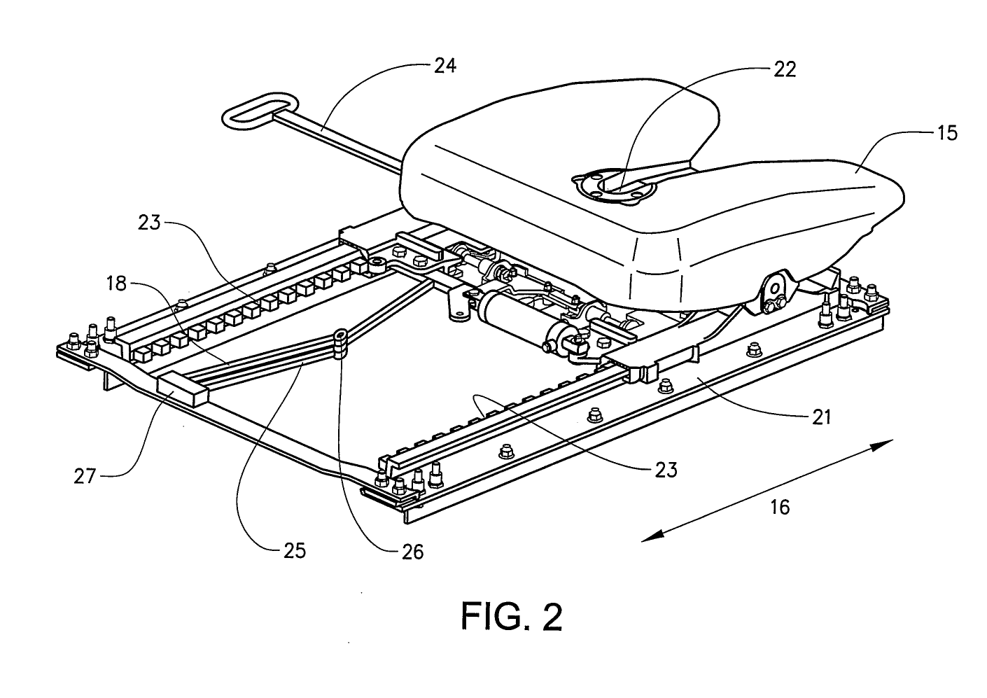

FIG. 2 illustrates an embodiment of the coupling device or “fifth wheel” 15 more in detail. The coupling device 15 is displaceable along arrow 16 in relation to a frame part 21, which is fixed to the body of the vehicle 10. The coupling device 15 defines a funnel-shaped recess 22 for receiving and releasable locking a ball-shaped connecting member (not shown) of the semi-trailer 13. Opposite rack-like formations 23 formed on the frame part 21 co-operates with corresponding locking members (not shown) formed on the displaceable coupling device 15, such that the coupling device may be displaced and releasable locked in any of a large number of possible positions by operating a handle 24. In the embodiment shown in FIG. 2 the position detector 18 comprises a longitudinally extending, articulated rod member 25 having a central hinge or pivot 26. The ends of the rod member 25 are connected to the displaceable coupling device 15 and to the fixed frame part 21, respectively, such that the parts of the rod member 25, which are interconnected by the hinge 26, mutually defines an angle varying in response to the position of the displaceable coupling device 15. An angle sensor 27 determines the angle value and transmits a corresponding signal to the calculating and display device 19, which may translate the angle value into an exact position of the “fifth wheel”.

It should be understood that various amendments of the embodiments described above could be made without departing from the scope of the present invention. As an example, any other conventional type of position detector than that described above could be used for determining the position of the coupling device or “fifth wheel” 15 in relation to the positions of the front and rear axles, respectively, of the towing vehicle 10.

1. A method of determining a load (L1) transferred from a semi-trailer to a first axle of a towing vehicle, the towing vehicle having at least one further, second axle, the semi-trailer being partly supported by the towing vehicle at a supporting site thereof, wherein a position of the supporting site in relation to the axles of the towing vehicle is changeable, the method comprising:
determining a first value representing a load (L2) transferred from the semi-trailer to the at least one further, second axle and
determining a second value (d1, d2) representing the position of the supporting site in relation to the axles using a position detecting device, and
calculating a value representing the load (L1) transferred from the semi-trailer to the first axle based on said the first and second values.

2. A method according to claim 1, wherein the supporting site is displaced between predetermined positions along a track extending longitudinally of the towing vehicle.

3. A method according to claim 2, wherein the supporting site is determined by a displaceable supporting member which is connected to a fixed part of the towing vehicle by an articulated rod member, the position of the supporting member being determined based on a mutual angular position of rod member parts.

4. A method according to claim 1, wherein the first and second axles are front and rear axles, the supporting site being positioned between the front and rear axles.

5. A method according to claim 4, wherein the load L1 transferred from the semi-trailer to the first axle is calculated based on the following equation:
L1*d1=L2*d2 or
L1=L2*d2/d1
wherein the load transferred from the semi-trailer to the second axle is L2 and the longitudinal distances between the supporting site and the first and second axles are d1 and d2, respectively.

6. A method according to claim 5, wherein the total load L3 transferred from the semi-trailer to the towing vehicle at the supporting site is calculated from the equation
L3=L1+L2.

7. A system for determining a load (L1) transferred from a semi-trailer to a first axle of a towing vehicle, the towing vehicle having at least one further, second axle, the semi-trailer being partly supported by the towing vehicle at a supporting site thereof, the system comprising;
a load sensing device for determining a first value representing the load (L2) transferred from the semi-trailer to the at least one further, second axle and
a position detecting device for determining a second value (d1, d2) representing the position of the supporting site in relation to the axles, and
an electronic calculator adapted to receive signals from the load sensing device and from the position detecting device representing the first and second values, respectively, and to calculate a value representing the load (L1) transferred from the semi-trailer to the first axle based on the first and second values.

8. A system according to claim 7, further comprising a display device communicating with the electronic calculator and adapted to display any of the values received and/or calculated by the calculator.

9. A system according to claim 7, wherein the position detecting device comprises an articulated rod member interconnecting a fixed part of the towing vehicle and a supporting member displaceable in relation to the vehicle, and an angle sensing device for determining the mutual angular position of the rod member parts.

10. A system according to claim 7, wherein the electronic calculator is calculating the load L1 transferred from the semi-trailer to the first axle based on the following equation:
L1*d1=L2*d2 or
L1=L2*l2*d2/d1
where the load transferred from the semi-trailer to the second axle is L2 and the longitudinal distances between the supporting site and the first and second axles are d1 and d2, respectively.

11. Computer program comprising program code on a medium readable by a computer for carrying out all the steps in claim 1 when the program is executed by a computer.

12. Computer program product comprising program code stored on a medium that can be read by computer for carrying out the method in claim 1 when the program is executed by a computer.

13. A method according to claim 2, wherein the first and second axles are front and rear axles, the supporting site being positioned between the front and rear axles.

14. A method according to claim 13, wherein the load L1 transferred from the semi-trailer to the first axle is calculated based on the following equation:
L1*d1=L2*d2 or
L1=L2*d2/d1
wherein the load transferred from the semi-trailer to the second axle is L2 and the longitudinal distances between the supporting site and the first and second axles are d1 and d2, respectively.

15. A method according to claim 14, wherein the total load L3 transferred from the semi-trailer to the towing vehicle at the supporting site is calculated from the equation L3=L1+L2.

16. A method according to claim 3, wherein the first and second axles are front and rear axles, the supporting site being positioned between the front and rear axles.

17. A method according to claim 16, wherein the load L1 transferred from the semi-trailer to the first axle is calculated based on the following equation:
L1*d1=L2*d2 or
L1=L2*d2/d1
wherein the load transferred from the semi-trailer to the second axle is L2 and the longitudinal distances between the supporting site and the first and second axles are d1 and d2, respectively.

18. A system according to claim 8, wherein the position detecting device comprises an articulated rod member interconnecting a fixed part of the towing vehicle and a supporting member displaceable in relation to the vehicle, and an angle sensing device for determining the mutual angular position of the rod member parts.

19. A system according to any of the claims 18, wherein the electronic calculator is calculating the load L1 transferred from the semi-trailer to the first axle based on the following equation:
L1*d1=L2*d2 or
L1=L2*l2*d2/d1
where the load transferred from the semi-trailer to the second axle is L2 and the longitudinal distances between the supporting site and the first and second axles are d1 and d2, respectively.

20. A system according to claim 8, wherein the electronic calculator is calculating the load L1 transferred from the semi-trailer to the first axle based on the following equation:
L1*d1=L2*d2 or
L1=L2*l2*d2/d1
where the load transferred from the semi-trailer to the second axle is L2 and the longitudinal distances between the supporting site and the first and second axles are d1 and d2, respectively.
